(19) United States
(12) Patent Application Publication
(10) Pub. No.: US 2021/0402986 A1
(43) Pub. Date: Dec. 30, 2021

(54) VEHICLE CONTROL DEVICE

(71) Applicant: HITACHI ASTEMO, LTD., Ibaraki (JP)

(72) Inventors: Masato IMAI, Tokyo (JP); Naoyuki TASHIRO, Tokyo (JP); Satoru OKUBO, Ibaraki (JP); Shinsaku TSUKADA, Ibaraki (JP)

(73) Assignee: HITACHI ASTEMO, LTD., Ibaraki (JP)

(21) Appl. No.: 17/294,524

(22) PCT Filed: Nov. 8, 2019
(86) PCT No.: PCT/JP2019/043802

§ 371 Date: May 17, 2021

(30) Foreign Application Priority Data
Nov. 22, 2018 (JP) 2018-219554

(51) Int. Cl. B60W 30/06; G08G 1/16; B60W 30/095; B60W 50/14

(52) U.S. Cl. CPC B60W 30/06; B60W 50/14; B60W 30/0956; G08G 1/16

(57) ABSTRACT

The present invention sets an appropriate parking route according to a surrounding situation. A vehicle control device which controls traveling of a vehicle includes: a surrounding environment recognition unit which recognizes a surrounding environment of an own vehicle, detects a parking space, sets a target parking position and a travelable space; and a vehicle control unit which guides and controls the own vehicle to the target parking position in the travelable space. The vehicle control unit guides and controls the own vehicle to the target parking position without traveling the own vehicle in a space behind the target parking position.

### TECHNICAL FIELD

The present invention relates to a vehicle control device that guides and controls a vehicle to a target parking position by automatic steering and automatic speed control.

### BACKGROUND ART

There is a technology of setting a route to a target parking position and controlling a steering and a speed of a vehicle so that the vehicle moves along the set route to park the vehicle.

For example, PTL 1 (JP 2008-296638 A) discloses a parking support device calculating a target locus from a parking start position to a target parking position to guide a vehicle and including: a determination means which determines whether or not an initial target locus intersects with a long axis (Z-axis) of a parking section in a case where the vehicle cannot be guided to the target parking position by the initial target locus in which a steering angle is not changed beyond a neutral state; and a target locus setting means which sets the target locus according to a determination result by the determination means.

In addition, PTL 2 (JP 2014-227021 A) discloses a parking support device in which a driver specifies a target parking position and a parking method by a target parking position/parking method specification unit in a video around a vehicle captured from a vehicle that has stopped in the vicinity of the target parking position, a target movement route generation unit generates a target movement route of a vehicle from a current position to the specified target parking position, a parking operation execution unit moves the vehicle according to the generated target movement route, a parking completion decision unit decides that the movement of the vehicle has been completed, and when a deviation amount calculation unit calculates a magnitude and a direction of a deviation between a position of the vehicle at that time and the target parking position, the target movement route generation unit generates a target movement route in which a deviation is not generated on the basis of magnitudes and directions of deviations between positions of the vehicle and the target parking position at the time of completion of parking plural times in the past, stored in a deviation amount memory unit.

### CITATION LIST

### Patent Literature

PTL 1: JP 2008-296638 A

PTL 2: JP 2014-227021 A

### SUMMARY OF INVENTION

### Technical Problem

If a technology disclosed in PTL 1 is used, the vehicle can be automatically parked at the target parking position specified by the driver. However, in a parallel parking frame as illustrated in FIG. 3(d) of PTL 2, in a situation where a length of the parking frame in a longitudinal direction is approximately the same as or slightly longer than an overall length of an own vehicle, the vehicle travels across front and rear frame lines at the time of entering the parking frame. Therefore, in a case where the vehicle is parked in such a narrow parallel parking frame, if the vehicle travels across a rear frame line of the target parking position, for example, there is a possibility that the vehicle will hinder traveling of another vehicle tried to be parked forward in a rear parking frame in advance or collide with another vehicle.

The present invention has been made in view of the above circumstance, and an object of the present invention is to set an appropriate parking route according to a surrounding situation.

### Solution to Problem

A representative example of the invention disclosed in the present application is as follows. That is, a vehicle control device which controls traveling of a vehicle includes: a surrounding environment recognition unit which recognizes a surrounding environment of an own vehicle, detects a parking space, sets a target parking position and a travelable space; and a vehicle control unit which guides and controls the own vehicle to the target parking position in the travelable space. The vehicle control unit guides and controls the own vehicle to the target parking position without traveling the own vehicle in a space behind the target parking position.

### Advantageous Effects of Invention

According to an aspect of the present invention, an appropriate parking route can be set according to the surrounding situation. Objects, configurations, and effects other than those described above will become apparent from a description of embodiments provided below.

### BRIEF DESCRIPTION OF DRAWINGS

FIG. 1 is a schematic configuration diagram of an automatic parking device according to a first embodiment of the present invention.

FIG. 2 is a flowchart illustrating an operation of a vehicle control device according to the first embodiment of the present invention.

FIG. 3 is a flowchart of idle processing according to the first embodiment of the present invention.

FIG. 4 is a flowchart of parking space search processing according to the first embodiment of the present invention.

FIG. 5 is a flowchart of automatic parking processing according to the first embodiment of the present invention.

FIG. 6 is a flowchart of turn-back processing according to the first embodiment of the present invention.

FIG. 7 is a flowchart of vehicle stop response processing according to the first embodiment of the present invention.

FIG. 8 is a flowchart of travelable space setting processing according to the first embodiment of the present invention.

FIG. 9 is a diagram illustrating an example of travelable space setting of parallel parking.

FIG. 10 is a diagram illustrating an example of travelable space setting of parallel parking.

FIG. 11 is a diagram illustrating an example of travelable space setting of parallel parking.

FIG. 12 is a diagram illustrating an example of travelable space setting of parallel parking.

FIG. 13 is a diagram illustrating an example of travelable space setting of parallel parking in a case where an obstacle exists in front of a vehicle.

FIG. 14 is a diagram illustrating an example of travelable space setting of parallel parking in a case where an obstacle exists behind a vehicle.

FIGS. 15A-15C is a diagram illustrating an example of control in a case where an obstacle has been detected during guidance control of an own vehicle.

FIG. 16 is a diagram illustrating a screen for notifying an occupant of information.

FIG. 17 is a diagram illustrating an example of travelable space setting and route setting of parallel parking.

### DESCRIPTION OF EMBODIMENTS

Hereinafter, embodiments will be described with reference to the drawings.

### First Embodiment

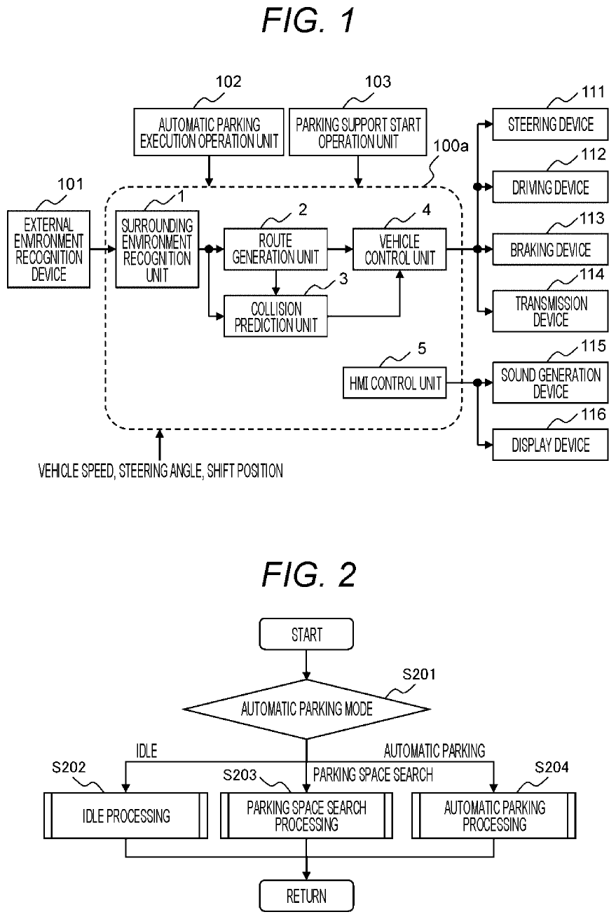

FIG. 1 is a schematic configuration diagram of a vehicle control device according to a first embodiment of the present invention.

The control device 100a illustrated in FIG. 1 is a computer that controls an own vehicle, and functions as a surrounding environment recognition unit 1, a route generation unit 2, a collision prediction unit 3, a vehicle control unit 4, and a human machine interface (HMI) control unit 5 by executing a program stored in a storage medium (not illustrated).

The control device 100a is connected to a steering device 111, a driving device 112, a braking device 113, a transmission device 114, an external environment recognition device 101, a sound generation device 115, a display device 116, an automatic parking execution operation unit 102, and a parking support start operation unit 103. In addition, the control device 100a is connected to a controller area network (CAN) (not illustrated) or the like of the own vehicle, and receives vehicle information such as a vehicle speed, a steering angle, a shift position, and the like, of the own vehicle.

The external environment recognition device 101 is a device that acquires information regarding a surrounding environment of the own vehicle, and can be composed of, for example, four in-vehicle cameras that photograph the surrounding environments of the front, the rear, the right side, and the left side of the own vehicle, respectively. Images obtained by the in-vehicle cameras are transmitted to the control device 100a as analog data using a dedicated line or the like or are converted into digital data and then transmitted to the control device 100a using a dedicated line or the like. In addition, in addition to the in-vehicle cameras, a radar that measures a distance to an object using a millimeter wave or a laser, a sonar that measures a distance to an object using an ultrasonic wave, or the like, can be used, and obtained information such as the distance to the object, a direction angle, and the like, is transmitted to the control device 100a using a dedicated line or the like.

The steering device 111 is composed of an electric power steering, a hydraulic power steering, or the like whose steering angle can be controlled by an electric or hydraulic actuator or the like by a drive command from the outside.

The driving device 112 is composed of an engine system whose engine torque can be controlled by an electric throttle or the like by a drive command from the outside, an electric power train system in which a driving force can be controlled by a motor or the like by a drive command from the outside, or the like.

The braking device 113 is composed of an electric brake, a hydraulic brake or the like whose braking force can be controlled by an electric or hydraulic actuator or the like by a braking command from the outside.

The transmission device 114 is composed of a transmission or the like in which forward movement or backward movement can be switched by an electric or hydraulic actuator or the like by a shift command from the outside.

The sound generation device 115 is composed of a speaker or the like, and outputs an alarm, a voice guidance or the like to a driver.

The display device 116 is composed of a display such as a navigation device or the like, a meter panel, a warning light, or the like. In addition to an operation screen of the control device 100a, a warning screen or the like visually informing the driver that the own vehicle is in danger of colliding with an obstacle is displayed on the display device 116.

The parking support start operation unit 103 is an operation member provided at a position where the driver can perform an operation, and outputs a start signal for starting an operation of the control device 100a to the control device 100a on the basis of the operation of the driver. In addition, the operation of the control device 100a may be configured to be terminated by the operation of the parking support start operation unit 103 while the control device 100a is executing processing.

The automatic parking execution operation unit 102 is an operation member provided at a position where the driver can perform an operation, and outputs a start signal for starting an operation of the control device 100a to the control device 100a on the basis of the operation of the driver.

Note that the parking support start operation unit 103 and the automatic parking execution operation unit 102 can be installed as switches in a place around a steering wheel where an operation is easily operated by the driver or may be configured so that they can be operated by the driver by being displayed as operation buttons on the display device 116 in a case where the display device 116 is a touch panel type display.

The surrounding environment recognition unit 1 detects a shape or a position of an object such as a stationary three-dimensional object, a moving body, a road surface paint such as a parking frame line or the like, a sign, or the like, around the own vehicle using image data obtained by capturing images of the surroundings of the own vehicle, input from the external environment recognition device 101. Further, the surrounding environment recognition unit 1 has a function of detecting an unevenness or the like of a road surface and determining whether or not the road surface is a road surface on which the own vehicle can travel. The stationary three-dimensional object is, for example, a parked vehicle, a wall, a pole, a pylon, a curb, a car stopper, or the like. In addition, the moving body is, for example, a pedestrian, a bicycle, a motorcycle, a vehicle, or the like. Hereinafter, the stationary three-dimensional object and the moving body are collectively referred to as an obstacle. The shape or the position of the object can be detected using pattern matching or other known technologies. The position of the object may be expressed using, for example, a coordinate system having an origin at a position of an in-vehicle camera that photographs the front of the own vehicle.

In addition, the surrounding environment recognition unit 1 detects a parkable space, which is a space in which the own vehicle can be parked, a travelable space, which is a space in which the own vehicle can turn in order to be parked in the parkable space, or the like, for example, in a case of a parking lot on the basis of information regarding the detected shape or position of the object and a determination result of whether or not the road surface is the road surface on which the own vehicle can travel. Note that the travelable space is defined using a passage width, a distance to an obstacle in front of the own vehicle, a position of an obstacle (parked vehicle) adjacent to the parkable space, and the like.

The route generation unit 2 generates a route for moving the own vehicle from a current position to a target position. For example, in the case of the parking lot, the route generation unit 2 sets a target parking position where the own vehicle is to be parked in the parkable space and generates a route in the travelable space, from a positional relationship between the own vehicle and the obstacle.

The collision prediction unit 3 determines whether or not the own vehicle collides with the obstacle when the own vehicle travels along the route generated by the route generation unit 2. The collision prediction unit 3 predicts a movement route of the moving body on the basis of a recognition result of the surrounding environment recognition unit 1, and determines whether or not the own vehicle collides with the moving body at an intersection between the route of the own vehicle and the predicted route of the moving body. In addition, the collision prediction unit 3 similarly decides whether or not the own vehicle collides with a newly detected stationary three-dimensional object or moving body when the own vehicle is traveling.

The vehicle control unit 4 controls the own vehicle to move along a target route generated by the route generation unit 2. Specifically, the vehicle control unit 4 calculates a target steering angle and a target speed on the basis of the target route. Then, the vehicle control unit 4 outputs a target steering torque for realizing the calculated target steering angle to the steering device 111. In addition, the vehicle control unit 4 outputs a target engine torque and a target brake pressure for realizing the target speed, respectively, to the driving device 112 and the braking device 113. In addition, in a case where the collision prediction unit 3 predicts a collision between the own vehicle and the obstacle, the vehicle control unit 4 calculates a target steering angle and a target speed so that the own vehicle does not collide with the obstacle, and outputs control parameters based on the calculated target steering angle and target speed to the steering device 111, the driving device 112, and the braking device 113. Further, in a case where it is decided that the own vehicle has reached a turn-back position and it is necessary to change a traveling direction, a shift command is output to the transmission device 114.

The HMI control unit 5 appropriately generates information to be notified to the driver or an occupant according to a situation, and outputs the information to the sound generation device 115 and the display device 116.

Next, a processing procedure of the control device 100a will be described using a flowchart.

A processing procedure of the control device 100a will be described with reference to FIGS. 2 to 8.

FIG. 2 is a flowchart illustrating an operation of the control device 100a. Processing illustrated in FIG. 2 is repeatedly executed at a predetermined timing.

In processing S201 of FIG. 2, processing is changed on the basis of a current automatic parking mode. In a case where the automatic parking mode is idle, the processing proceeds to idle processing of processing S202, in a case where the automatic parking mode is parking space search, the processing proceeds to processing S203, and in a case where the automatic parking mode is automatic parking, the processing proceeds to processing S204.

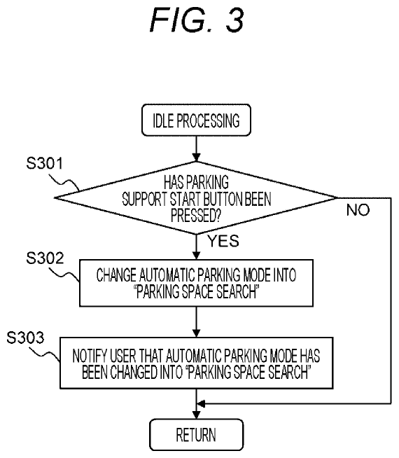

FIG. 3 is a flowchart of idle processing.

In processing S301 of FIG. 3, it is determined whether or not the parking support start operation unit 103 has been operated, and in a case where the parking support start operation unit 103 has been operated, the processing proceeds to processing S302 and in a case where the parking support start operation unit 103 has not been operated, the processing ends.

The automatic parking mode is changed into the parking space search in processing S302, a user is notified that the automatic parking mode has been changed in processing S303, and the processing ends.

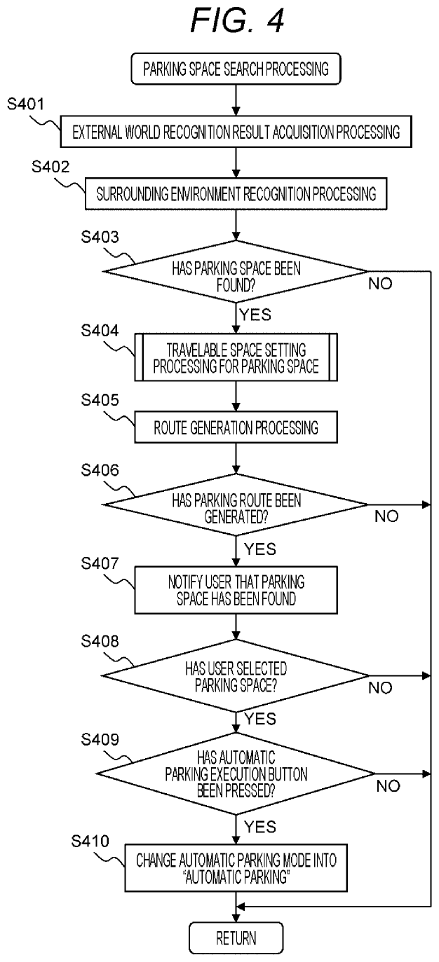

FIG. 4 is a flowchart of parking space search processing.

In processing S401, if the control device 100a acquires image data from the external environment recognition device 101, the control device 100a executes external world recognition result acquisition processing.

In processing S402, the surrounding environment recognition unit 1 of the control device 100a executes surrounding environment recognition processing for detecting a shape or a position of an object such as a stationary three-dimensional object, a moving body, a road surface paint such as a parking frame line or the like, a sign, or the like, around the own vehicle from the image data acquired in processing S401. In addition, the surrounding environment recognition unit 1 detects a travelable space on the basis of information regarding the detected shape or position of the object and a determination result of whether or not the road surface is a road surface (for example, a flat surface) on which the own vehicle can travel. For example, in a case where the road surface is a parking lot, the surrounding environment recognition unit 1 detects a parkable space partitioned by a parking frame line. Then, a target parking position is set in the parkable space. The surrounding environment recognition unit 1 may set the target parking position according to a selection by the driver or an assistant from a plurality of detected parkable spaces or the surrounding environment recognition unit 1 may automatically set an optimum target parking position.

The surrounding environment recognition unit 1 determines whether or not the parkable space has been found in processing S403, and proceeds to processing S404 in a case where the parkable space has been found and ends the processing in a case where the parkable space has not been found.

In processing S404, the surrounding environment recognition unit 1 executes travelable space setting processing for setting the found parkable space as the travelable space.

The route generation unit 2 executes route generation processing for generating a parking route through which the own vehicle can reach the parking space detected in processing S403 from a current position of the own vehicle in processing S405, and determines whether or not the parking route could be generated in processing S406. Then, the route generation unit 2 proceeds to processing S407 in a case where the parking route could be generated, and ends the processing in a case where the parking route could not be generated.

The HMI control unit 5 notifies the driver that the parking space has been found in processing S407, determines whether or not the user has selected the parking space in processing S408, and proceeds to processing S409 in a case where the driver has selected the parking space to determine whether or not the automatic parking execution operation unit 102 has been operated. Then, in a case where the HMI control unit 5 has detected the operation of the automatic parking execution operation unit 102, the HMI control unit 5 proceeds to processing S410 to change the automatic parking mode into the automatic parking, and ends the processing. On the other hand, in a case where the user has not selected the parking space in processing S408 and in a case where the operation of the automatic parking execution operation unit 102 has not been detected in processing S409, the processing ends.

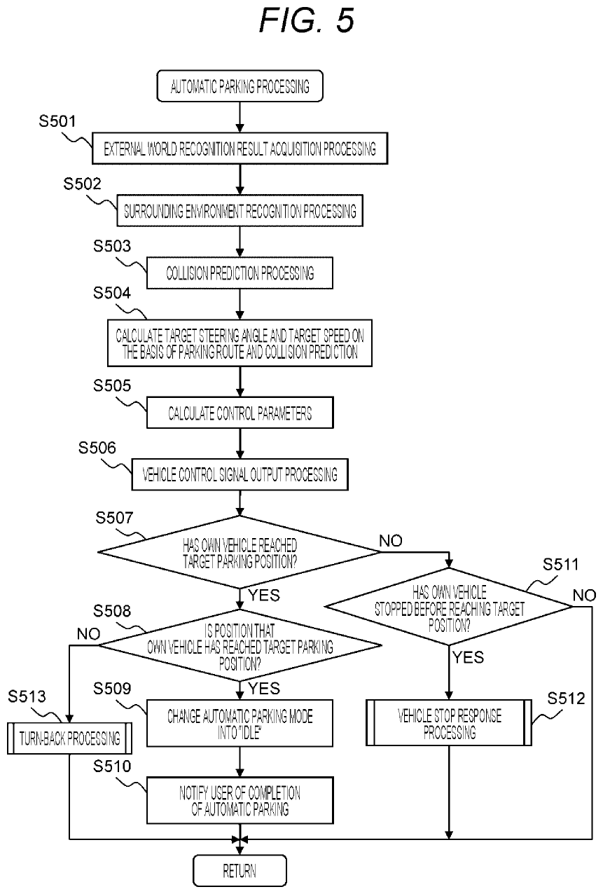

FIG. 5 is a flowchart of automatic parking processing.

In processing S501 and processing S502, the surrounding environment recognition unit 1 executes external world recognition result acquisition processing and surrounding environment recognition processing, similar to processing S401 and processing S402 of FIG. 4.

In processing S503, the collision prediction unit 3 executes collision prediction processing for determining a possibility that the own vehicle will collide with an obstacle in a case where the own vehicle moves along the parking route generated in processing S405.

In processing S504, the vehicle control unit 4 calculates a target steering angle and a target speed of the own vehicle on the basis of the parking route generated in processing S405 and a collision prediction result determined in processing S503.

In processing S505, the vehicle control unit 4 calculates control parameters output to the steering device 111, the driving device 112, and the braking device 113 in order to control the vehicle according to the target steering angle and the target speed calculated in processing S504. For example, as the control parameter output to the steering device 111, there is a target steering torque for realizing the target steering angle, but the target steering angle may be directly output depending on a configuration of the steering device 111. In addition, the control parameters output to the driving device 112 and the braking device 113 are a target engine torque, a target braking pressure and the like for realizing the target speed, but the target speed may be directly output depending on configurations of the driving device 112 and the braking device 113.

In processing S506, the vehicle control unit 4 executes vehicle control signal output processing for outputting the control parameters calculated in processing S505 to the steering device 111, the driving device 112, and the braking device 113.

In processing S507, the vehicle control unit 4 determines whether or not the own vehicle has reached the target parking position, proceeds to processing S508 in a case where the own vehicle has reached the target parking position, and proceeds to processing S511 in a case where the own vehicle has not been reached the target parking position.

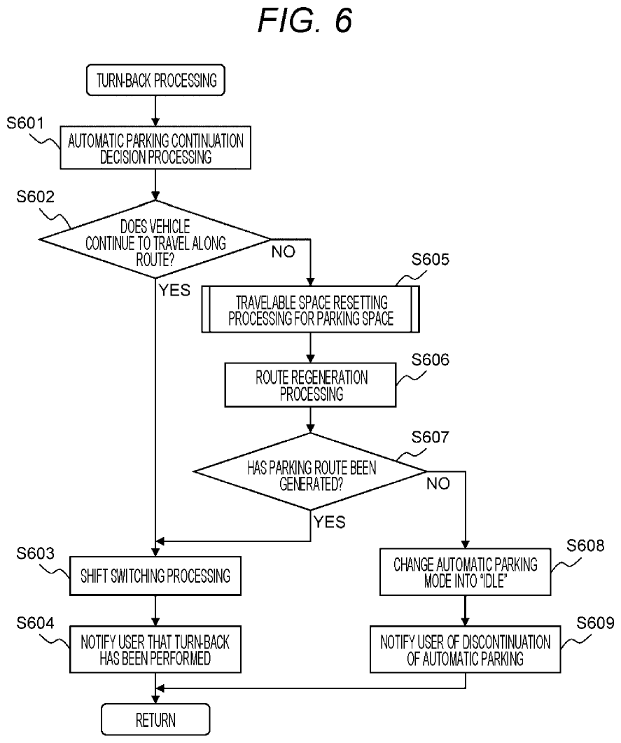

The vehicle control unit 4 determines whether or not a position that the own vehicle has reached is the target parking position in processing S508, proceeds to processing S509 to change the automatic parking mode into idle in a case where the position that the own vehicle has reached is the target parking position, notifies the user of completion of the automatic parking in processing S510, and ends the processing. On the other hand, in a case where it is determined in processing S508 that the position that the own vehicle has reached is not the target parking position, the vehicle control unit 4 proceeds to processing S513 to execute turn-back processing (FIG. 6), and then ends the processing.

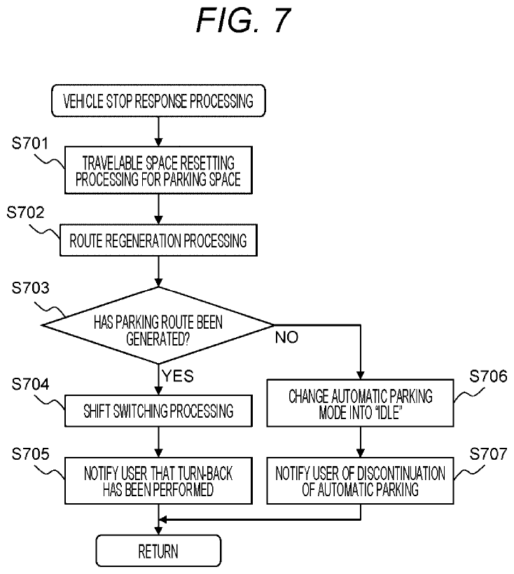

The vehicle control unit 4 determines whether or not the own vehicle has stopped before reaching the target position in processing S511, proceeds to processing S512 in a case where the own vehicle has stopped before reaching the target position to execute vehicle stop response processing (FIG. 7), and then ends the processing. On the other hand, in a case where it is determined in processing S511 that the own vehicle does not stopped before reaching the target position, the vehicle control unit 4 ends the processing as it is without changing the automatic parking mode.

FIG. 6 is a flowchart of the turn-back processing, and illustrates details of processing S513 of the automatic parking processing (FIG. 5).

In processing S601, the vehicle control unit 4 determines whether or not the vehicle can continue to travel along the parking route calculated in processing S405 at a turn-back position where the own vehicle stops. For example, the vehicle control unit 4 compares the target parking position set in processing S402 of the parking space search processing (FIG. 4) at the time of the start of parking with the target parking position set in processing S502 of the automatic parking processing (FIG. 5) when the vehicle has reached the turn-back position, and determines that the vehicle cannot travel along the parking route generated by processing S405, for example, in a case where the two target parking positions are spaced apart from each other by a predetermined threshold value (for example, 10 cm) or more or in a case where a direction of the vehicle deviates by a predetermined threshold value (for example, 3°) or more.

The vehicle control unit 4 proceeds to processing S603 in a case where it has been decided in a determination result in processing S601 that the vehicle can continue to travel along the route, in processing S602. The vehicle control unit 4 executes shift switching processing for outputting a command value to the transmission device 114 in order to switch a shift position in processing S603, and the HMI control unit 5 notifies the user that turn-back has been performed in processing S604 and ends the processing.

On the other hand, the vehicle control unit 4 proceeds to processing S605 in a case where it has been decided in the determination result in processing S601 that the vehicle cannot continue to travel along the route, in processing S602. The surrounding environment recognition unit 1 resets the travelable space for the parking space in processing S605, and the route generation unit 2 executes route regeneration processing for recalculating the parking route in processing S606. Processing S605 and processing S606 may be the same as processing S404 and processing S405, respectively.

The route generation unit 2 determines whether or not the parking route could be generated in processing S606, in processing S607. The route generation unit 2 proceeds to processing S603 in a case where the parking route could be generated, and proceeds to processing S608 in a case where the parking route could not be generated The vehicle control unit 4 changes the automatic parking mode into idle in processing S608, and the HMI control unit 5 notifies the user of discontinuation of the automatic parking in processing S609 and ends the processing.

Note that in processing S604 and processing S609, guidance control of the vehicle may be continued or discontinued after an operation from the user is received by the HMI control unit 5 or the like.

FIG. 7 is a flowchart of the vehicle stop response processing, and illustrates details of processing S512 of the automatic parking processing (FIG. 5).

The surrounding environment recognition unit 1 executes travelable space resetting processing for resetting the travelable space for the parking space in processing S701, and the route generation unit 2 executes route regeneration processing for recalculating the parking route in processing S702. Processing S701 and processing S702 may be the same as processing S404 and processing S405, respectively.

The route generation unit 2 determines whether or not the parking route could be generated in processing S702, in processing S703. The route generation unit 2 proceeds to processing S704 in a case where the parking route could be generated. The vehicle control unit 4 executes shift switching processing for outputting a command value to the transmission device 114 in order to switch a shift position in processing S704, and the HMI control unit 5 notifies the user that turn-back has been performed in processing S705 and ends the processing.

On the other hand, the route generation unit 2 proceeds to processing S706 in a case where the parking route could not be generated. The vehicle control unit 4 changes the automatic parking mode into idle in processing S706, and the HMI control unit 5 notifies the user of discontinuation of the automatic parking in processing S707 and ends the processing.

Note that in processing S705 and processing S707, guidance control of the vehicle may be continued or discontinued after an operation from the user is received by the HMI control unit 5 or the like.

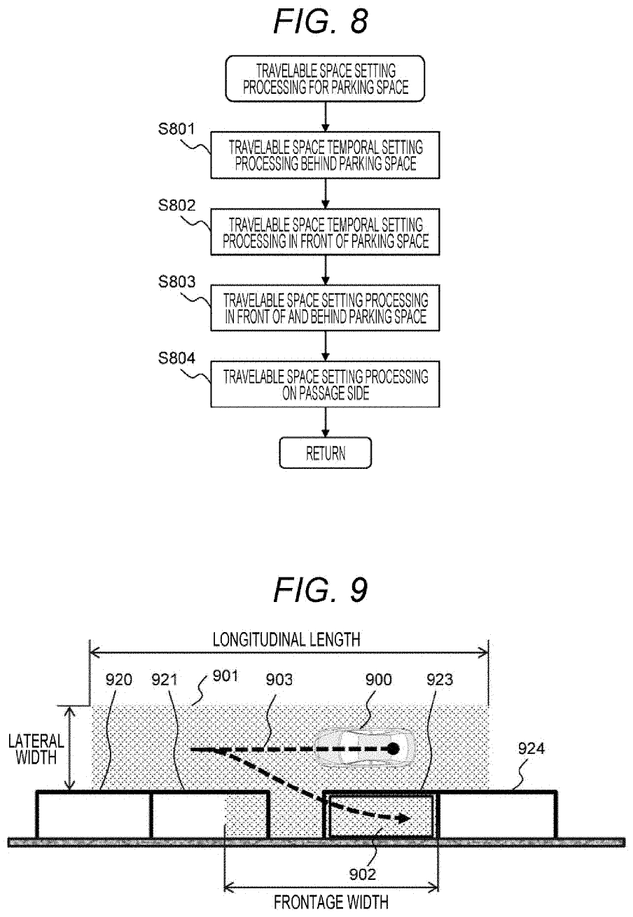

FIG. 8 is a flowchart of the travelable space setting processing for the parking space, and illustrates details of processing S404 of the parking space search processing (FIG. 4). Note that processing illustrated in FIG. 8 is also executed in the travelable space resetting processing of processing S605 of the turn-back processing (FIG. 6) and processing S701 of the vehicle stop response processing (FIG. 7).

In processing S801, the surrounding environment recognition unit 1 temporarily sets a travelable space behind the parking space. Specifically, the surrounding environment recognition unit 1 determines whether or not another parking space or an obstacle such as another vehicle or the like exists behind the parking space, and calculates each of distances obtained by subtracting a margin distance Mf (for example, 0.5 m) from a distance from a rear end of the parking space to another parking space and a distance from the rear end of the parking space to the obstacle. In a case where only one of another parking space and the obstacle exists behind the parking space, the surrounding environment recognition unit 1 temporarily set a distance to the existing one as a travelable space behind the parking space, and in a case where both of another parking space and the obstacle exist behind the parking space, the surrounding environment recognition unit 1 temporarily sets a smaller distance of the calculated distances as a travelable space behind the parking space. In a case where both of another parking space and the obstacle do not exist behind the parking space, the surrounding environment recognition unit 1 temporarily sets a fixed distance (for example, 5 m) as a travelable space behind the parking space.

In processing S802, the surrounding environment recognition unit 1 temporarily sets a travelable space in front of the parking space. Specifically, the surrounding environment recognition unit 1 determines whether or not an obstacle such as another vehicle or the like exists in front of the parking space, and calculates a distance obtained by subtracting a margin distance Mf (for example, 0.5 m) from a distance from a front end of the parking space to the obstacle. In a case where the obstacle exists in front of the parking space, the surrounding environment recognition unit 1 temporarily sets the calculated distance as a travelable space in front of the parking space, and in a case where the obstacle does not exist in front of the parking space, the surrounding environment recognition unit 1 temporarily sets a fixed distance (for example, 5 m) as a travelable space in front of the parking space.

In processing S803, the surrounding environment recognition unit 1 sets travelable spaces in front of and behind the parking space using information of the travelable spaces temporarily set in processing S801 and processing S802. A total length of the parking space and the travelable spaces in front of and behind the parking space is defined as a frontage width. This frontage width is set using a width at which a route can be generated with the minimum number of times of turn-back as a reference value (for example, 7 m). Specifically, the frontage width is set as the reference value so that the travelable spaces in front of and behind the parking space have the same length, and in a case where the travelable spaces in front of and behind the parking space have different lengths, the lengths of the travelable spaces in front of and behind the parking space are adjusted so that the frontage width becomes the reference value. In addition, in a case where the total length of the parking space and the travelable spaces in front of and behind the parking space does not reach the reference value of the frontage width, it is preferable to adjust the lengths of the travelable spaces in front of and behind the parking space so that the frontage width becomes maximum within a range of the reference value. A method of distributing the travelable spaces in front of and behind the parking space is not limited to that described above, and can be implemented by various methods.

In processing S804, the surrounding environment recognition unit 1 sets a travelable space on a passage side. A width of a travelable space set on a passage on which the own vehicle is traveling while searching for the parking space is defined as a lateral width, and a length of the travelable space is defined as a longitudinal length. The lateral width is set using a width at which a route can be generated with the minimum number of times of turn-back as a reference value (for example, 4 m), and is a distance from the parking space. In a case where a passage width is narrow or in a case where a passage width becomes narrow due to an obstacle, the distance from the parking space does not reach the reference value, but in that case, the largest value in a range that can be taken is adopted. Similarly, the longitudinal length is set using a length at which a route can be generated with the minimum number of times of turn-back as a reference value (for example, 20 m), and is preferentially set on a side (advance direction side) ahead of the parking space.

By executing the processing according to the flowchart described above, it is possible to set travelable spaces in consideration of front and rear obstacles without entering a rear parking space.

Next, examples and methods of setting a travelable space will be described with reference to FIGS. 9 to 15.

FIG. 9 illustrates a case where an own vehicle 900 is parallel-parked in a front parallel frame 923 of two series of parallel frames 920 and 921, and 923 and 924. If a driver selects the parallel frame 923 in which he/she wants to park the own vehicle 900 at a position of the own vehicle 900 illustrated in FIG. 9, the parallel frame 923 is set as a target parking position 902. Next, a travelable space 901 is set for the target parking position 902 so as to avoid a rear parallel frame 924. This is because there is a possibility that another vehicle will enter the rear parallel frame 924 from behind the own vehicle in order to be parked in the rear parallel frame 924. By setting the travelable space so as to avoid the rear parallel frame 924, a collision between the own vehicle and another vehicle is avoided in advance, and the parking of another vehicle is not hindered.

Here, the travelable space 901 is also set in a front parallel frame 921, but since a possibility that another vehicle will enter the parallel frame 921 after the start of guidance control is low, if an obstacle is not detected in the parallel frame 921, a possibility that the own vehicle will collide with the obstacle such as another vehicle or the like is low. For this reason, the travelable space 901 is set so as to include a part or the entirety of the front parallel frame 921, which is a range necessary for performing turn-back to park the own vehicle. Note that in a case where another vehicle that has entered the parallel frame 921 has been detected after the start of the guidance control or in a case where a new obstacle has been detected, a route is only required to be regenerated so as to avoid another vehicle or the obstacle that has been detected, at point in time when the own vehicle 900 has reached a first turn-back position.

In addition, a frontage width of the travelable space 901 is set using a width at which a route can be generated with the minimum number of times of turn-back as a reference value (for example, 7 m), a longitudinal length of the travelable space 901 is similarly set using a length at which a route can be generated with the minimum number of times of turn-back as a reference value (for example, 20 m), a lateral width of the travelable space 901 is similarly set using a width at which a route can be generated with the minimum number of times of turn-back as a reference value (for example, 4 m), and the frontage width, the longitudinal length, and the lateral width are appropriately changed from the reference values in a case where an obstacle or the like exists. The own vehicle 900 sets the travelable space 901, calculates a route 903 for the own vehicle to reach the target parking position 902 in this travelable space, and starts guidance control of the vehicle. By performing the setting as described above, it becomes possible to perform efficient parallel parking with the small number of times of turn-back while giving consideration to safety for another vehicle.

FIG. 10 illustrates a case where an own vehicle 1000 is parallel-parked in a rear parallel frame 1021 of two series of parallel frames 1020 and 1021, and 1023 and 1024. In this case, by calculation similar to that of FIG. 9, a travelable space 1001 is set so as to avoid rear parallel frames 1023 and 1024, a route 1003 for the vehicle to reach a target parking position 1002 is calculated, and the vehicle is guided and controlled.

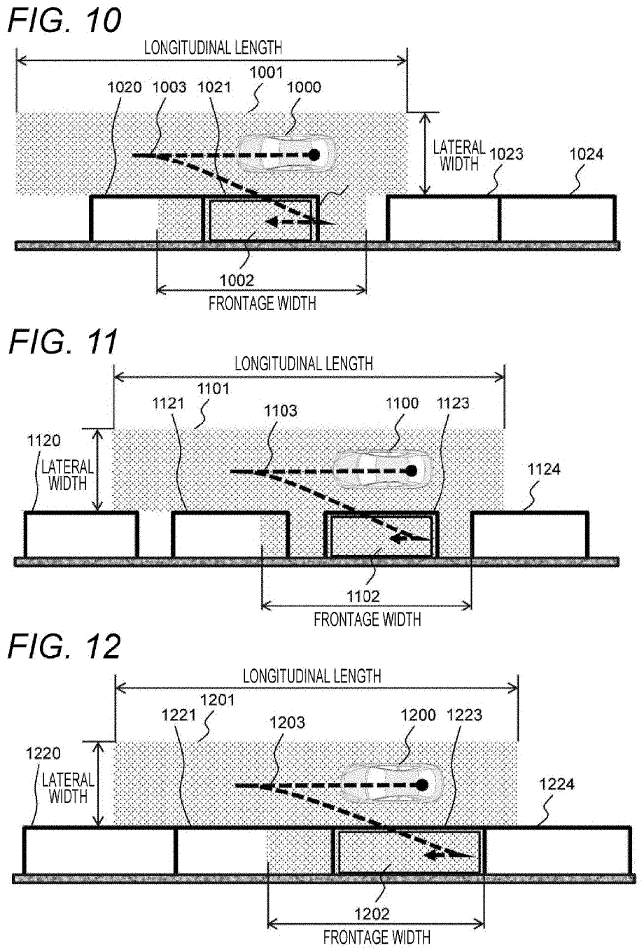

FIG. 11 illustrates a case where an own vehicle 1100 is parallel-parked in one parallel frame 1123 of independent parallel frames 1120, 1121, 1123, and 1124. In this case, by calculation similar to that of FIG. 9, a travelable space 1101 is set so as to avoid a rear parallel frame 1124, a route 1103 for the vehicle to reach a target parking position 1102 is calculated, and the vehicle is guided and controlled.

FIG. 12 illustrates a case where an own vehicle 1200 is parallel-parked in one parallel frame 1223 of continuous parallel frames 1220, 1221, 1223, and 1224. In this case, by calculation similar to that of FIG. 9, a travelable space 1201 is set so as to avoid a rear parallel frame 1224, a route 1203 for the vehicle to reach a target parking position 1202 is calculated, and the vehicle is guided and controlled.

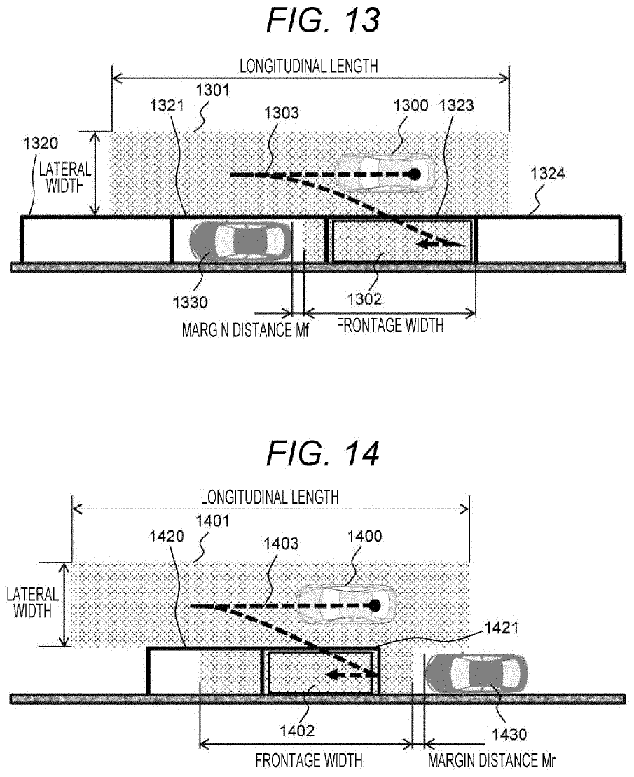

FIG. 13 illustrates a case where when another vehicle 1330 exists in one parallel frame 1321 of continuous parallel frames 1320, 1321, 1323, and 1324 illustrated in FIG. 12, an own vehicle 1300 is parallel-parked in a parallel frame 1323 behind the parallel frame 1321. In this case, a travelable space is set with a margin distance Mf (for example, 0.5 m) between the own vehicle and another vehicle in front of the own vehicle, a route 1303 for the vehicle to reach a target parking position 1302 is calculated, and the vehicle is guided and controlled.

FIG. 14 illustrates a case where when another vehicle exists without a parallel frame behind, an own vehicle 1400 is parallel-parked in a rear parallel frame 1421 of two series of parallel frames 1420 and 1421. In this case, a travelable space is set with a margin distance Mr (for example, 0.5 m) between the own vehicle and another vehicle 1430 behind the own vehicle, a route 1403 for the vehicle to reach a target parking position 1402 is calculated, and the vehicle is guided and controlled.

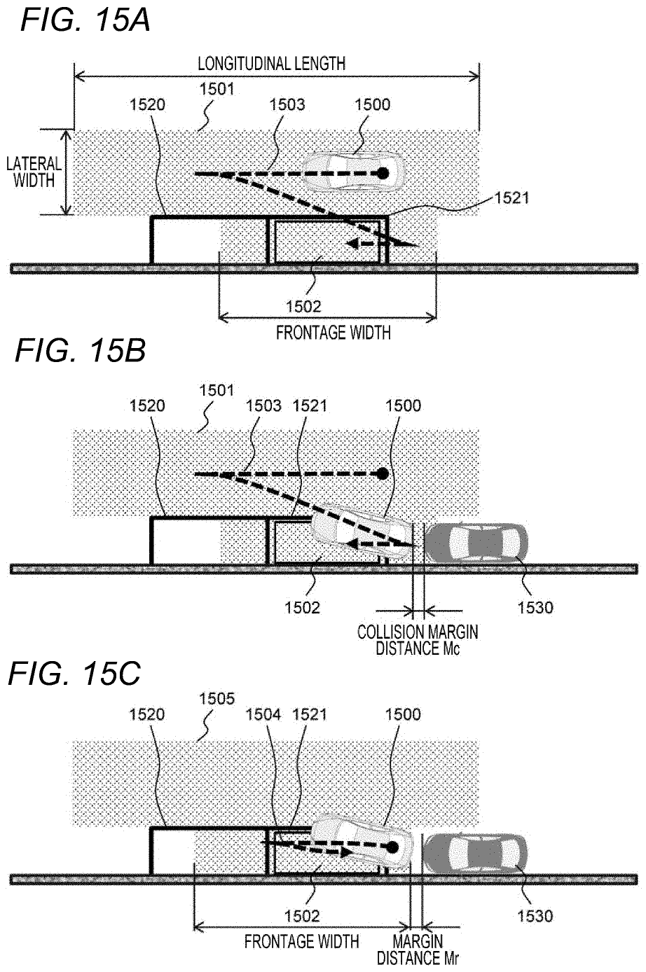

FIGS. 15A-15C illustrates guidance control in a case where when an own vehicle 1500 is parallel-parked in a rear parallel frame 1521 of two series of parallel frames 1520 and 1521, another vehicle enters a travelable space 1501 after the start of guidance control. As illustrated in FIG. 15B, if the own vehicle detects another vehicle 1530 while it is reversing, the vehicle is stopped with a collision margin distance of Mc (for example, 0.3 m). Thereafter, as illustrated in FIG. 15C, a travelable space is reset with a margin distance Mr from another vehicle 1530, a route 1504 up to a target parking position is regenerated in the reset travelable space 1505, and guidance control of the vehicle is restarted. As described above, even though an obstacle is detected during the guidance control, the guidance control can be restarted without a stop by stopping the vehicle in front of the obstacle, setting a new travelable space from a stop position, and calculating a route, and convenience can thus be improved.

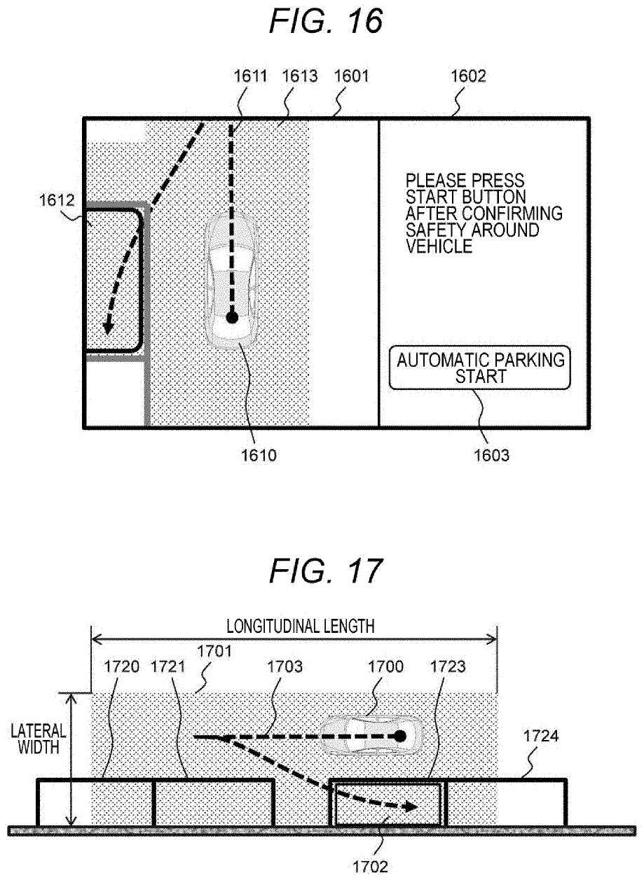

FIG. 16 is a diagram illustrating an example of a display screen generated by the HMI control unit 5 or the like.

On a left side of the screen, an overhead view image display area 1601 that displays an overhead view image in which videos of four cameras attached to the front, the rear, the left, and the right of the vehicle are combined with each other is provided, and a route 1611 for an own vehicle 1610 to reach a target parking position 1612 selected by a driver and a travelable space 1613 are displayed. Note that at least one of the target parking position 1612, the route 1611, and the travelable space 1613 may be displayed. In addition, in an operation display area 1602 on a right side of the screen, a message to a driver is displayed, and a button 1603 for receiving an operation of the driver is provided on a touch panel.

### Second Embodiment

Next, a method of setting a travelable space and a route according to a second embodiment of the present invention will be described.

FIG. 17 illustrates a case where an own vehicle 1700 is parallel-parked in a front parallel frame 1723 of two series of parallel frames 1720 and 1721, and 1723 and 1724, similar to the case illustrated in FIG. 9. In the second embodiment, a travelable space 1701 is set so as to include a rear parallel frame 1724, but a route 1703 is generated so that the own vehicle does not enter the rear parallel frame 1724. Note that in a case where the route cannot be generated only by front parallel frames 1720 and 1721, the route 1703 in which the own vehicle enters the rear parallel frame 1724 may be generated. That is, in the second embodiment, the route 1703 is generated by preferentially using the front parallel frames 1720 and 1721. By setting such a route, a collision between the own vehicle and another vehicle is avoided in advance and parking of another vehicle is not hindered, similar to the first embodiment. Then, it becomes possible to perform efficient parallel parking with the small number of times of turn-back while giving consideration to safety for another vehicle.

Note that some patterns of parallel parking have been illustrated in the present specification, but the present invention can also be applied to other patterns of parallel parking. In addition, it can be performed in various aspects without departing from the spirit of the present invention.

As described above, according to the embodiment of the present invention, since the vehicle control unit 4 guides and controls the own vehicle to the target parking position 902 without traveling the own vehicle in the space (for example, the rear parallel frame 924) behind the target parking position 902, it is possible to realize appropriate automatic parking according to the surrounding situation.

In addition, since the surrounding environment recognition unit 1 detects a space (for example, the rear parallel frame 924) that another vehicle may enter after the start of the guidance control and sets the travelable space 901 so as not to include the detected space, it is possible to realize appropriate automatic parking according to the surrounding situation.

In addition, since the surrounding environment recognition unit 1 determines that the parking space (parallel frame 924) detected adjacent to the rear of the target parking position 902 is a space that another vehicle may enter and sets the travelable space 901 so as not to include the parking space 924, at the time of the parallel parking, it is possible to realize efficient automatic parking with the small number of times of turn-back while avoiding a risk of a collision between the own vehicle and the surrounding vehicle even in a case of parking the own vehicle in a parallel narrow parking frame.

In addition, since the surrounding environment recognition unit 1 determines that the own vehicle can travel to a predetermined area of the parking space (parallel frame 921) detected adjacent to the front of the target parking position 902 and sets the travelable space 901 so as to include a part or the entirety of the parking space 921, at the time of the parallel parking, it is possible to effectively utilize a space and shorten a parking time.

In addition, since the surrounding environment recognition unit 1 sets the travelable space 1301 or 1401 so as to avoid the obstacle (another vehicle 1330 or 1430) in a case where the obstacle has been detected near the target parking position 1302 or 1402, it is possible to perform the guidance control so as to prevent a collision between the own vehicle and the obstacle and safely park the own vehicle.

In addition, since the surrounding environment recognition unit 1 sets the travelable space 1301 at a position spaced apart from the obstacle by a predetermined distance Mf in a case where the obstacle (another vehicle 1330) has been detected in front of the target parking position, it is possible to perform the guidance control so as to prevent a collision between the own vehicle and the obstacle and safely park the own vehicle.

In addition, since the surrounding environment recognition unit 1 sets the travelable space at a position spaced apart from the obstacle by a predetermined distance Mr in a case where the parking space cannot be detected behind the target parking position 902 and the obstacle (another vehicle 1430) has been detected behind the target parking position, it is possible to perform the guidance control so as to prevent a collision between the own vehicle and the obstacle and safely park the own vehicle.

In addition, since the vehicle control unit 4 guides and controls the own vehicle according to the route generated by the route generation unit 2, it is possible to realize efficient automatic parking with the small number of times of turn-back while avoiding a risk of a collision between the own vehicle and the surrounding vehicle.

In addition, since the surrounding environment recognition unit 1 detects the surrounding obstacle of the own vehicle after the start of the guidance control and the vehicle control unit 4 performs control so that the own vehicle stops in front of the obstacle in a case where a collision between the own vehicle and the detected obstacle is predicted, it is possible to perform the guidance control so as to prevent a collision between the own vehicle and another vehicle and safely park the own vehicle.

In addition, since the route generation unit 2 generates the route 1504 for the own vehicle to reach the target parking position from the stop position of the own vehicle in a case where the own vehicle has stopped on the basis of the prediction result of the collision prediction unit 3, the vehicle control unit 4 guides and controls the own vehicle according to a generated route 1504 in a case where a new route 1504 could be generated, and an information notification unit (HMI control unit 5) notifies the occupant that the own vehicle cannot be guided and controlled in a case where the new route 1504 could not be generated, it is possible to realize efficient automatic parking while preventing a collision between the own vehicle and another vehicle.

In addition, the information notification unit (HMI control unit 5) notifies the occupant of at least one of the travelable space 1613, the target parking position 1612, and the route 1611, and can thus notify the occupant of a situation of the vehicle. That is, the occupant can know how the vehicle travels.

In addition, since the route generation unit 2 generates the route 1703 for the own vehicle to reach the target parking position 1702 from the position of the own vehicle by preferentially using the travelable space in front of the target parking position 1702, it is possible to set an appropriate parking route according to the surrounding situation.

In addition, since the route generation unit 2 generates the route using the travelable space behind the target parking position in a case where the route cannot be generated using the travelable space in front of the target parking position, it is possible to set an appropriate parking route even through the space in front of the target parking position is narrow.

Note that the present invention is not limited to the embodiments described above, and includes various modifications and equivalent configurations within the scope of the attached claims. For example, the embodiments described above have been described in detail in order to explain the present invention in an easy-to-understand manner, and the present invention is not necessarily limited to including all the configurations described. In addition, some of configurations of a certain embodiment may be replaced with configurations of another embodiment. In addition, configurations of another embodiment may be added to configurations of a certain embodiment. In addition, other configurations may be added, deleted, and replaced with respect to some of configurations of the respective embodiments.

In addition, each of the configurations, the functions, the processing units, the processing means, and the like, described above may be realized by hardware by designing some or all of these configurations, functions, processing units, processing means, and the like, with for example, integrated circuits or may be realized by software by interpreting and executing programs realizing each function by a processor.

Information such as programs, tables, files or the like, realizing each function can be stored in a memory, a hard disk, a storage device such as a solid state drive (SSD) or the like, or a recording medium such as an integrated chip (IC) card, a security digital (SD) card, or a digital versatile disk (DVD), or the like.

In addition, control lines or information lines considered to be necessary for the description are illustrated, and all control lines or information lines necessary for implementation are not necessarily illustrated. In fact, it may be considered that almost all the configurations are connected to each other.

### REFERENCE SIGNS LIST

1 surrounding environment recognition unit
2 route generation unit
3 collision prediction unit
4 vehicle control unit
5 HMI control unit
100a control device
101 external environment recognition device
102 automatic parking execution operation unit
103 parking support start operation unit
111 steering device
112 driving device
113 braking device
114 transmission device
115 sound generation device
116 display device
900, 1000, 1100, 1200, 1300, 1400, 1500, 1700 own vehicle
901, 1001, 1101, 1201, 1301, 1401, 1501, 1701 travelable space
902, 1002, 1102, 1202, 1302, 1402, 1502, 1702 target parking position
903, 1003, 1103, 1203, 1303, 1403, 1503, 1703 route
920 to 924, 1020 to 1024, 1120 to 1124, 1220 to 1224, 1320 to 1324,
1420 to 1421, 1520 to 1521, 1720 to 1724 parallel frame
1330, 1430 another vehicle
1601 overhead view image display area
1602 operation display area
1603 button
1610 own vehicle
1611 route
1612 target parking position

1. A vehicle control device which controls traveling of a vehicle, comprising:
a surrounding environment recognition unit which recognizes a surrounding environment of an own vehicle, detects a parking space, sets a target parking position and a travelable space; and
a vehicle control unit which guides and controls the own vehicle to the target parking position in the travelable space,
wherein the vehicle control unit guides and controls the own vehicle to the target parking position without traveling the own vehicle in a space behind the target parking position.

2. The vehicle control device according to claim 1, wherein
the surrounding environment recognition unit detects a space that another vehicle enters after the start of the guidance control and sets the travelable space so as not to include the detected space.

3. The vehicle control device according to claim 2, wherein
the surrounding environment recognition unit determines that a parking space detected adjacent to a rear of the target parking position is a space that another vehicle enters and sets the travelable space so as not to include the parking space, at the time of parallel parking.

4. The vehicle control device according to claim 2, wherein
the surrounding environment recognition unit determines that the own vehicle travels to a predetermined area of a parking space detected adjacent to a front of the target parking position and sets the travelable space so as to include a part or entirety of the parking space, at the time of parallel parking.

5. The vehicle control device according to claim 2, wherein
the surrounding environment recognition unit sets the travelable space so as to avoid an obstacle in a case where the obstacle has been detected near the target parking position.

6. The vehicle control device according to claim 5, wherein
the surrounding environment recognition unit sets the travelable space at a position spaced apart from the obstacle by a predetermined distance in a case where the obstacle has been detected in front of the target parking position.

7. The vehicle control device according to claim 5, wherein
the surrounding environment recognition unit sets the travelable space at a position spaced apart from the obstacle by a predetermined distance in a case where a parking space is not detected behind the target parking position and the obstacle has been detected behind the target parking position.

8. The vehicle control device according to claim 2,
further comprising a route generation unit which generates a route for the own vehicle to reach the target parking position from a position of the own vehicle in the travelable space,
wherein the vehicle control unit guides and controls the own vehicle according to the route.

9. The vehicle control device according to claim 8,
further comprising a collision prediction unit which predicts whether or not the own vehicle collides with a surrounding obstacle,
wherein the surrounding environment recognition unit detects the surrounding obstacle of the own vehicle after the start of the guidance control, and
the vehicle control unit performs control so that the own vehicle stops in front of the obstacle in a case where a collision between the own vehicle and the detected obstacle is predicted.

10. The vehicle control device according to claim 9,
further comprising an information notification unit which notifies an occupant of information regarding vehicle control,
the route generation unit generates a route for the own vehicle to reach the target parking position from a stop position of the own vehicle in a case where the own vehicle has stopped on the basis of a prediction result of the collision prediction unit,
the vehicle control unit guides and controls the own vehicle according to the generated route in a case where the route is generated, and
an information notification unit notifies the occupant that the own vehicle is not guided and controlled in a case where the route is not generated.

11. The vehicle control device according to claim 2, further comprising:
a route generation unit which generates a route for the own vehicle to reach the target parking position from a position of the own vehicle in the travelable space; and
an information notification unit which notifies an occupant of at least one of the travelable space, the target parking position, and the route.

12. The vehicle control device according to claim 1,
further comprising a route generation unit which generates a route for the own vehicle to reach the target parking position from a position of the own vehicle by preferentially using a travelable space in front of the target parking position.

13. The vehicle control device according to claim 12, wherein
the route generation unit generates the route using a travelable space behind the target parking position in a case where the route is not generated using the travelable space in front of the target parking position.
